(19) United States
(12) Patent Application Publication
(10) Pub. No.: US 2024/0104683 A1
(43) Pub. Date: Mar. 28, 2024

(54) APPARATUS AND METHOD FOR GENERATING TILE VISIBILITY INFORMATION CONCURRENTLY BY SHARING GPU HARDWARE

(71) Applicant: QUALCOMM Incorporated, San Diego, CA (US)

(72) Inventors: Vishwanath Shashikant NIKAM, Bangalore (IN); Kalyan Kumar BHIRAVABHATLA, Bangalore (IN); Jian LIANG, San Diego, CA (US); Zhenbiao MA, Saratoga, CA (US); Siva Satyanarayana KOLA, Bangalore (IN); Suvam CHATTERJEE, Bangalore (IN)

(21) Appl. No.: 17/934,978

(22) Filed: Sep. 23, 2022

(51) Int. Cl. G06T 1/20; G06T 1/60

(52) U.S. Cl. CPC G06T 1/20; G06T 1/60

(57) ABSTRACT

The present disclosure relates to methods and apparatus for sharing GPU hardware to generate bin visibility information concurrently for graphics processing. The apparatus can cause a processor to: store, in a GMEM, first data associated with a first graphics processing pass for a first frame of graphics data and second data associated with a second graphics processing pass for a second frame of graphics data. The apparatus can also cause a geometry processor to perform the first graphics processing pass using the first data and a second processor to concurrently perform the second graphics processing pass using the second data such that the first graphics processing pass and the second graphics processing path share the geometry processor. In some aspects, the apparatus can switch the geometry processor from being used for the first graphics processing pass to being used for the second graphics processing pass at a primitive batch boundary.

### TECHNICAL FIELD

The present disclosure relates generally to processing systems and, more particularly, to one or more techniques for graphics processing.

### INTRODUCTION

Computing devices often utilize a graphics processing unit (GPU) or central processing unit (CPU) to accelerate the rendering of graphical data for display. Such computing devices may include, for example, computer workstations, mobile phones such as so-called smartphones, embedded systems, personal computers, tablet computers, and video game consoles. GPUs execute a graphics processing pipeline that includes one or more processing stages that operate together to execute graphics processing commands and output a frame. A CPU may control the operation of the GPU by issuing one or more graphics processing commands to the GPU. Modern day CPUs are typically capable of concurrently executing multiple applications, each of which may need to utilize the GPU during execution. A device that provides content for visual presentation on a display generally includes a GPU.

Typically, a GPU of a device is configured to perform the processes in a graphics processing pipeline. However, with the increasing complexity of rendered content and the physical constraints of GPU memory, there has developed an increased need for improved computer or graphics processing.

### SUMMARY

The following presents a simplified summary of one or more aspects in order to provide a basic understanding of such aspects. This summary is not an extensive overview of all contemplated aspects, and is intended to neither identify key elements of all aspects nor delineate the scope of any or all aspects. Its sole purpose is to present some concepts of one or more aspects in a simplified form as a prelude to the more detailed description that is presented later.

The present disclosure relates to methods and apparatus for graphics processing. The apparatus includes a memory, at least one processor comprising: a graphics memory (GMEM), a geometry processor coupled to the GMEM, and a second processor coupled to the GMEM, and at least one processor coupled to the memory. The processor is configured to store, in the GMEM, first data associated with a first graphics processing pass for a first frame of graphics data. The processor is also configured to store, in the GMEM, second data associated with a second graphics processing pass for a second frame of graphics data. The processor is further configured to cause the geometry processor to perform the first graphics processing pass using the first data. The processors is further configured to cause the second processor to perform the second graphics processing pass using the second data concurrently with the geometry processor performing the first graphics processing pass using the first data. The first graphics processing pass and the second graphics processing pass sharing the geometry processor.

Another further aspect of the subject matter described in this disclosure can be implemented in a method for graphics processing. The method includes storing, in the GMEM, first data associated with a first graphics processing pass for a first frame of graphics data. The method also includes storing, in the GMEM, second data associated with a second graphics processing pass for a second frame of graphics data. The method further includes causing the geometry processor to perform the first graphics processing pass using the first data. The method further comprises a second processor to perform the second graphics processing pass using the second data concurrently with the geometry processor performing the first graphics processing pass using the first data. The first graphics processing pass and the second graphics processing pass sharing the geometry processor.

Another further aspect of the subject matter described in this disclosure can be implemented in an apparatus for graphics processing. The apparatus includes means for storing, in the GMEM, first data associated with a first graphics processing for a first frame of graphics data, wherein the means for causing is further configured to: store, in the GMEM, second data associated with a second graphics processing pass for a second frame of graphics data, and cause a geometry processor to perform the first graphics processing pass using the first data, wherein the means for causing is further configured to: cause a second processor to perform the second graphics processing pass using the second data concurrently with the geometry processor performing the first graphics processing pass using the first data. The first graphics processing pass and the second graphics processing pass sharing the geometry processor.

Another further aspect of the subject matter described in this disclosure can be implemented in a non-transitory computer-readable medium storing computer-executable code including stored instructions of communications, executable by a processor to: store, in the GMEM, first data associated with a first graphics processing pass for a first frame of graphics data; store, in the GMEM, second data associated with a second graphics processing pass for a second frame of graphics data; cause a geometry processor to perform the first graphics processing pass using the first data; and cause a second processor to perform the second graphics processing pass using the second data concurrently with the geometry processor performing the first graphics processing pass using the first data. The first graphics processing pass and the second graphics processing pass sharing the geometry processor.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1A is a block diagram that illustrates an example of a content generation system in accordance with one or more techniques of this disclosure.

FIG. 1B is a block diagram that illustrates an example of a content generation system in accordance with one or more techniques of this disclosure.

FIG. 2 illustrates an example GPU in accordance with one or more techniques of this disclosure.

FIG. 3 illustrates an example architecture for performing a shared concurrent binning approach in accordance with one or more techniques of this disclosure.

FIG. 4 illustrates an example diagram for graphics processing in accordance with one or more techniques of this disclosure.

FIGS. 5 through 13 illustrate example flowcharts of various example methods for graphics processing in accordance with one or more techniques of this disclosure.

Like reference numbers and designations in the various drawings indicate like elements.

### DETAILED DESCRIPTION

The following description is directed to some particular aspects for the purposes of describing innovative aspects of this disclosure. However, a person having ordinary skill in the art will readily recognize that the teachings herein can be applied in a multitude of different ways.

Aspects of the present disclosure can reduce GPU area overhead since implementing additional geometry processors for bin visibility may add significant percentages of GPU area. For instance, aspects of the present disclosure can share GPU hardware using a selection of primitives associated with a first set of primitives for a first graphics processing pass and primitives associated with a second set of primitives for a second graphics processing pass for processing. By doing so, when aspects of the present disclosure perform two graphics processing passes, the two graphics processing passes share a GPU. As such, aspects of the present disclosure can save or conserve rendering or processing resources by using a workload selection process for sharing the GPU.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In general, this disclosure describes techniques for sharing a graphics processing pipeline for generating tile visibility information concurrently in a single device or multiple devices. This leads to improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a frame buffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

In general, GPUs can be used to render three-dimensional (3D) scenes. Because such rendering of 3D scenes can be very memory bandwidth-intensive, a specialized graphics memory (“GMEM”) may be used. GMEM may be located close to the graphics-processing core of the GPU so that it has a very high memory bandwidth (i.e., read and write access to the GMEM is fast). A scene can be rendered by the graphics processing core of the GPU to the GMEM, and the scene can be resolved from GMEM to memory (e.g., a frame buffer) so that the scene can then be displayed at a display device. The rendering of an entire frame, such as in this manner, may be referred to as immediate mode rendering. However, the size of the GMEM is limited due to physical memory constraints, such that the GMEM may not have sufficient memory capacity to contain an entire three-dimensional scene (e.g., an entire frame).

In some examples, a GPU or other processing device may be configured to split a 3D scene into tiles, so that each tile making up the scene can fit into GMEM. This is referred to as tile-based rendering or “binning”. As an example, if the GMEM is able to store 512 kB of data, then a scene may be divided into tiles such that the pixel data contained in each tile is less than or equal to 512 kB. In this way, the GPU or a second processor (e.g., a pixel processor in the GPU) may render the scene by dividing the scene into tiles that can be rendered into the GMEM and individually rendering each tile of the scene into the GMEM, storing the rendered tile from GMEM to a frame buffer, and repeating the rendering and storing for each tile of the scene. Accordingly, the GPU or second processor can render the scene tile-by-tile using multiple rendering passes (also referred to as bin rendering passes) to render each tile of the scene.

In exemplary implementations, tile-based rendering may be performed in several steps. For example, a GPU or other processor (e.g., a geometry processor in the GPU) implementing a tile-based architecture may initially process, or preprocess, an entire scene during a binning pass (also referred to as a bin visibility pass) to define a number of bins or “tiles.” The binning pass may be followed by a series of bin rendering passes, during which each of the defined tiles are rendered. In some examples, each of the rendering passes is completed in three stages: (1) clear/unresolve, (2) render, (3) resolve. During the clear/unresolve stage, the GPU may initialize GMEM for a new tile and store values into GMEM that have been read from an external memory. During rendering, the GPU or other processor (e.g., a geometry processor in the GPU that is dedicated for bin rendering passes) may recreate the polygons associated with a current tile. The GPU or second processor (e.g., the pixel processor) may also generate pixel values and finish a current tile, such that the tile can be displayed on a display. The resolve step may involve the GPU copying the contents of the on-chip memory (GMEM) to a system memory that is external to the GPU, such as a buffer for used by a display in displaying finished scenes.

During the binning pass, the GPU or geometry processor (e.g., a second geometry processor in the GPU dedicated for bin visibility passes) may generate polygons (e.g., triangles) that make up a scene and sort the polygons into the plurality of bins, which can be considered tiles of a final scene presented on a display. For example, each bin represents a portion of the final scene (e.g., a predefined portion of a frame of video data, computer-generated graphics image, still image, or the like). The tiles making up a scene can each be associated with a bin in memory (GMEM) that stores the primitives included in each respective tile. Thus, a binning pass can sort the primitives making up a scene into the appropriate bins. Moreover, the binning pass (the bin visibility pass) can also create a visibility stream for each bin for the frame that indicates whether any primitives in the bin will be visible in the final rendered scene or not. Accordingly, a visibility stream is a stream of bits that is configured as an input for the rendering passes to indicate whether or not a primitive is visible in each tile when rendered. If the visibility stream for a bin indicates that the bin does not contain any visible primitives (i.e., all of the primitives in the bin will not be visible in the final rendered scene), performance may be improved if the GPU does not render the primitives in the bin by skipping execution of the instructions in the indirect buffer associated with the bin.

GPU architecture may support tile based deferred rendering (TBDR), which will be explained in more detail below. TBDR may be performed sequentially or concurrently. In a concurrent scheme, the GPU begins the binning or bin visibility (BV) pass concurrently with bin rendering (BR) pass of a previous frame/render target. To accomplish this, separate bin visibility (or binning) pipe hardware is added to support the concurrency. In other words, dedicated geometry processing is needed for bin visibility generation in the CB architecture. The BV and BR pipes run in parallel with a BV pipe working on a subsequent frame while the BR pipe is working on a current frame.

Concurrent binning may be performed by sharing a geometry processing pipe for the BR and By. Instead of having two dedicated geometry processor, concurrent binning may use only one geometry processor that is shared to perform either BR or BV without starving the pixel processor for BR.

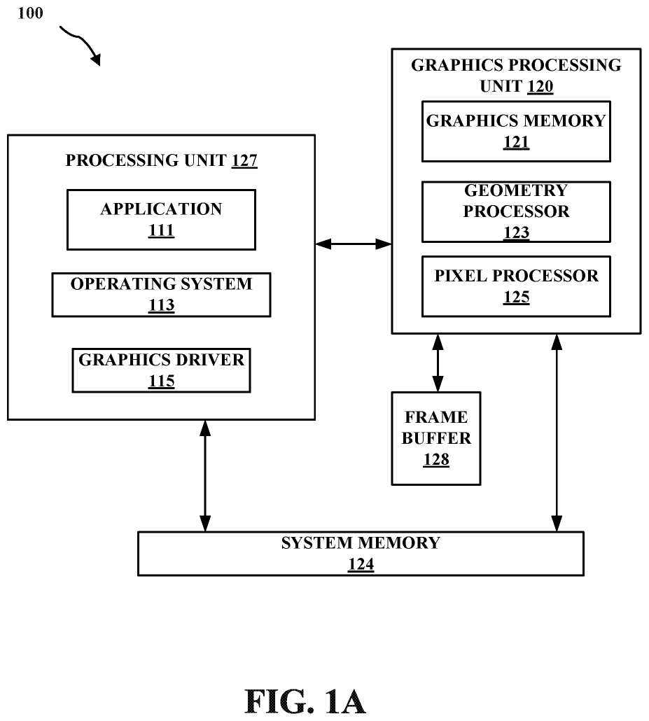

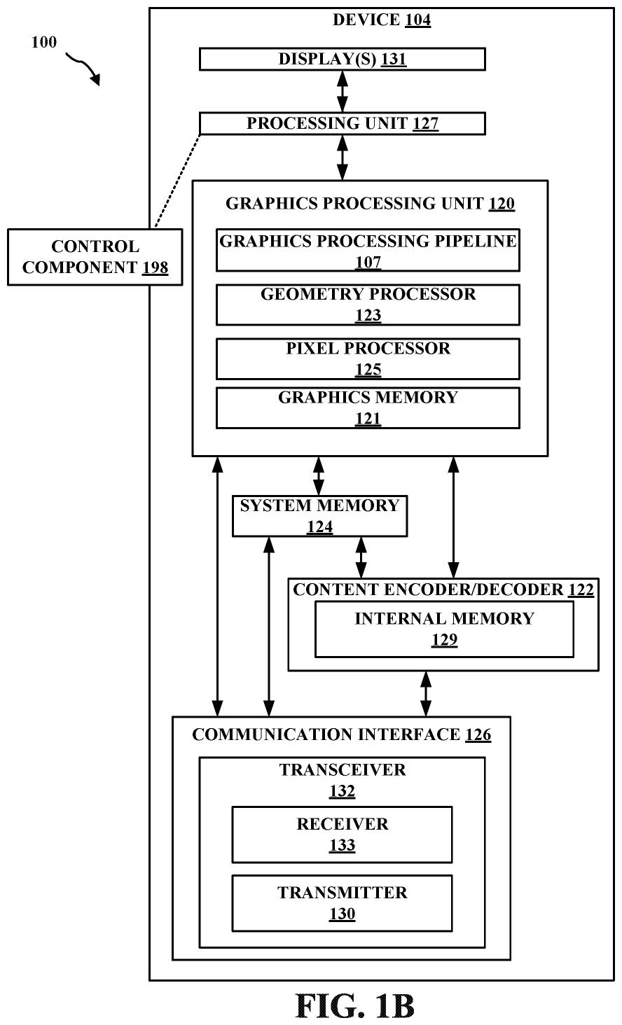

FIG. 1A is a block diagram that illustrates an example content generation system 100 configured to implement one or more techniques of this disclosure. As generally shown, the content generation system 100 includes a processing unit 127, a GPU 120, and a system memory 124 configured to render a 3D scene according to an exemplary aspects. Processing unit 127 may execute software application 111, operating system (OS) 113, and graphics driver 115. Moreover, system memory 124 may include indirect buffers that store the command streams for rendering primitives as well as secondary commands that are to be executed by GPU 120. GPU 120 may include graphics memory (GMEM) 121 that may be “on-chip” with GPU 120 that is coupled to a geometry processor 123 and a pixel processor 125. As described in more detailed with respect to FIG. 1B, the components of content generation system 100 may be part of a device, including, but are not limited to, video devices, media players, set-top boxes, wireless handsets such as mobile telephones and so-called smartphones, personal digital assistants (PDAs), desktop computers, laptop computers, gaming consoles, video conferencing units, tablet computing devices, and the like.

Processing unit 127 may be the central processing unit (CPU). GPU 120 may be a processing unit configured to perform graphics related functions such as generate and output graphics data for presentation on a display, as well as perform non-graphics related functions that exploit the massive processing parallelism provided by GPU 120. Because GPU 120 may provide general-purpose processing capabilities in addition to graphics processing capabilities, GPU 120 may be referred to as a general-purpose GPU (GP-GPU). Examples of processing unit 127 and GPU 120 include, but are not limited to, a digital signal processor (DSP), a general-purpose microprocessor, application specific integrated circuit (ASIC), field programmable logic array (FPGA), or other equivalent integrated or discrete logic circuitry. In some examples, GPU 120 may be a microprocessor designed for specific usage such as providing massive parallel processing for processing graphics, as well as for executing non-graphics related applications. Furthermore, although processing unit 127 and GPU 120 are illustrated as separate components, aspects of this disclosure are not so limited and can be, for example, residing in a common integrated circuit (IC).

Software application 111 that executes on processing unit 127 may include one or more graphics rendering instructions that instruct processing unit 127 to cause the rendering of graphics data to a display (not shown in FIG. 1A). In some examples, the graphics rendering instructions may include software instructions that may conform to a graphics application programming interface (API). In order to process the graphics rendering instructions, processing unit 127 may issue one or more graphics rendering commands to GPU 120 (e.g., through graphics driver 115) to cause GPU 120 to perform some or all of the rendering of the graphics data. In some examples, the graphics data to be rendered may include a list of graphics primitives, e.g., points, lines, triangles, quadrilaterals, triangle strips, etc.

GPU 120 may be configured to perform graphics operations to render one or more graphics primitives to a display. Accordingly, when one of the software applications executing on processing unit 127 requires graphics processing, processing unit 127 may provide graphics commands and graphics data to GPU 120 for rendering to the display. The graphics data may include, e.g., drawing commands, state information, primitive information, texture information, etc. GPU 120 may, in some instances, be built with a highly parallel structure that provides more efficient processing of complex graphic-related operations than processing unit 127. For example, GPU 120 may include a plurality of processing elements that are configured to operate on multiple vertices or pixels in a parallel manner.

GPU 120 may be directly coupled to GMEM 121. In other words, GPU 120 may process data locally using a local storage, instead of off-chip memory. This allows GPU 120 to operate in a more efficient manner by eliminating the need of GPU 120 to read and write data via, e.g., a shared bus, which may experience heavy bus traffic. GMEM 121 may include one or more volatile or non-volatile memories or storage devices, such as, e.g., random access memory (RAM), static RAM (SRAM), dynamic RAM (DRAM), and one or more registers.

The GMEM 121 may also be directly coupled to at least a geometry processor 123 and a second processor (e.g., a pixel processor 125). In some cases, the GPU 120 may utilize the geometry processor 123 to process polygons and perform transforms, such as translation, scaling, rotation, field-of-view, and depth test near and far field clipping, among others, for an image to be made, and the pixel processor 125 to associate data to pixels for the image to be made. The geometry processor 123 may be configured to perform bin visibility passes in tile-based deferred rendering, such as at least applying geometric transformations to the vertices of primitives, marking which bins or tiles of a frame include a visible primitive (e.g., a polygon such as a triangle), and generating a visibility stream. The pixel processor 125 may be configured to perform bin rendering passes in tile-based deferred rendering, such as at least rendering a frame one bin or tile at a time using the visible primitives indicated in the visibility stream. The geometry processor 123 may also be configured to perform bin rendering passes in tile-based deferred rendering, such as at least transforming primitives and performing shading computations to be used for subsequent rendering by the pixel processor 125. In some aspects, the processors that perform the above-described functions may be a general processors (e.g., CPU).

The geometry processor 123 may be a CPU, a GPU, a general-purpose GPU (GPGPU), or any other processing unit that may be configured to perform graphics processing. In some examples, geometry processor 123 may be integrated into a motherboard of the device 104. In some examples, geometry processor 123 may be present on a graphics card that is installed in a port in a motherboard of the device 104 or may be otherwise incorporated within a peripheral device configured to interoperate with the device 104. The geometry processor 123 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the geometry processor 123 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The pixel processor 125 may be a CPU, a GPU, a GPGPU, or any other processing unit that may be configured to perform graphics processing. In some examples, pixel processor 125 may be integrated into a motherboard of the device 104. In some examples, the pixel processor 125 may be present on a graphics card that is installed in a port in a motherboard of the device 104 or may be otherwise incorporated within a peripheral device configured to interoperate with the device 104. The pixel processor 125 may include one or more processors, such as one or more microprocessors, GPUs, ASICs, FPGAs, ALUs, DSPs, discrete logic, software, hardware, firmware, other equivalent integrated or discrete logic circuitry, or any combinations thereof. If the techniques are implemented partially in software, the pixel processor 125 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

Processing unit 127 and/or GPU 120 may store rendered image data in a frame buffer 128, which may be an independent memory or may be is allocated within system memory 124. A display processor may retrieve the rendered image data from frame buffer 128 and display the rendered image data on a display.

System memory 124 may be a memory in the device and may reside external to processing unit 127 and GPU 120, i.e., off-chip with respect to processing unit 127, and off-chip with respect to GPU 120. System memory 124 may store applications that are executed by processing unit 127 and GPU 120. Furthermore, system memory 124 may store data upon which the executed applications operate, as well as the data that result from the application.

System memory 124 may store program modules, instructions, or both that are accessible for execution by processing unit 127, data for use by the programs executing on processing unit 127, or two or more of these. For example, system memory 124 may store a window manager application that is used by processing unit 127 to present a graphical user interface (GUI) on a display. In addition, system memory 124 may store user applications and application surface data associated with the applications. As explained in detail below, system memory 124 may act as a device memory for GPU 120 and may store data to be operated on by GPU 120 as well as data resulting from operations performed by GPU 120. For example, system memory 124 may store any combination of texture buffers, depth buffers, stencil buffers, vertex buffers, frame buffers, or the like.

Examples of system memory 124 include, but are not limited to, a random-access memory (RAM), a read only memory (ROM), or an electrically erasable programmable read-only memory (EEPROM), or any other medium that can be used to carry or store desired program code in the form of instructions or data structures and that can be accessed by a computer or a processor. As one example, system memory 124 may be removed from the device, and moved to another device. As another example, a storage device, substantially similar to system memory 124, may be inserted into the device.

FIG. 1B is a more detailed block diagram that illustrates an example content generation system 100 configured to implement one or more techniques of this disclosure. It is noted that the content generation system 100 shown in FIG. 1B corresponds to that of FIG. 1A. In this regard, the content generation system 100 of FIG. 1B includes a processing unit 127, a GPU 120 and a system memory 124.

As further shown, the content generation system 100 includes a device 104 that may include one or more components configured to perform one or more techniques of this disclosure. In the example shown, the device 104 may include a GPU 120, a content encoder/decoder 122, and system memory 124. In some aspects, the device 104 can include a number of additional and/or optional components, e.g., a communication interface 126, a transceiver 132, a receiver 133, and a transmitter 130, and one or more displays 131. Reference to the display 131 may refer to the one or more displays 131. For example, the display 131 may include a single display or multiple displays. The display 131 may include a first display and a second display. In further examples, the results of the graphics processing may not be displayed on the device, e.g., the displays 131 may not receive any frames for presentment thereon. Instead, the frames or graphics processing results may be transferred to another device. In some aspects, this can be referred to as hybrid-rendering.

The GPU 120 includes graphics memory (GMEM) 121. The GPU 120 may be configured to perform graphics processing, such as in a graphics processing pipeline 107. The graphics processing pipeline 107 may include at least bin visibility passes and bin rendering passes. The GPU 120 may be configured to perform these passes in the graphics processing pipeline 107 using at least the GMEM 121, a geometry processor 123 coupled to the GMEM 121, and a second processor (e.g., pixel processor 125) coupled to the GMEM 121. The content encoder/decoder 122 may include an internal memory 129. In some examples, the device 104 may include a display processor, such as the processing unit 127, to perform one or more display processing techniques on one or more frames generated by the GPU 120 before presentment by the one or more displays 131 as described above. The processing unit 127 may be configured to perform display processing. The one or more displays 131 may be configured to display or otherwise present frames processed by the processing unit 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the GPU 120 and the content encoder/decoder 122, such as system memory 124 as described above, may be accessible to the GPU 120 and the content encoder/decoder 122. For example, the GPU 120 and the content encoder/decoder 122 may be configured to read from and/or write to external memory, such as the system memory 124. The GPU 120 and the content encoder/decoder 122 may be communicatively coupled to the system memory 124 over a bus. In some examples, the GPU 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The GMEM 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that GMEM 121 or the system memory 124 is non-movable or that its contents are static. As one example, the system memory 124 may be removed from the device 104 and moved to another device. As another example, the system memory 124 may not be removable from the device 104.

The GPU may be configured to perform graphics processing according to the exemplary techniques as described herein. In some examples, the GPU 120 may be integrated into a motherboard of the device 104. In some examples, the GPU 120 may be present on a graphics card that is installed in a port in a motherboard of the device 104, or may be otherwise incorporated within a peripheral device configured to interoperate with the device 104. The GPU 120 may include one or more processors, such as one or more microprocessors, GPUs, ASICs, FPGAs, ALUs, DSPs, discrete logic, software, hardware, firmware, other equivalent integrated or discrete logic circuitry, or any combinations thereof. If the techniques are implemented partially in software, the GPU 120 may store instructions for the software in a suitable, non-transitory computer-readable storage medium and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content encoding/decoding. In some examples, the content encoder/decoder 122 may be integrated into a motherboard of the device 104. The content encoder/decoder 122 may include one or more processors, such as one or more microprocessors, ASICs, FPGAs, ALUs, DSPs, video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 129, and may execute the instructions in hardware using one or more processors to perform the techniques of this disclosure. Any of the foregoing, including hardware, software, a combination of hardware and software, etc., may be considered to be one or more processors.

In some aspects, the content generation system 100 can include an optional communication interface 126. The communication interface 126 may include a receiver 133 and a transmitter 130. The receiver 133 may be configured to perform any receiving function described herein with respect to the device 104. Additionally, the receiver 133 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 133 and the transmitter 130 may be combined into a transceiver 132. In such examples, the transceiver 132 may be configured to perform any receiving function and/or transmitting function described herein with respect to the device 104.

Referring again to FIG. 1A, in certain aspects, the processing unit 127 may include a control component 198 that is configured to control the processor (comprising a CPU or GPU) or general-purpose processor to perform bin visibility passes and bin rendering passes using a shared geometry processor. Moreover, the control component 198 can be configured to store, in the GMEM, first data associated with a first graphics processing pass for a first frame of graphics data; and also store, in the GMEM, second data associated with a second graphics processing pass for a second frame of graphics data. In an aspect, the control component 198 also be configured to cause the geometry processor to perform the first graphics processing pass using the first data and a second processor (e.g., the pixel processor) to perform the second graphics processing pass using the second data concurrently with the geometry processor performing the first graphics processing pass using the first data. In another aspect, the control component 198 can be configured to receive a first command for processing a first set of primitive indices using the first graphic processing pass, receive a second command for processing a second set of primitive indices using the second graphics processing pass; determine whether the first set of primitive indices comprises at least one first primitive batch for the first graphics processing pass and whether the second set of primitive indices comprises at least one second primitive batch for the second graphics processing pass; and store, in the GMEM, the first data and the second data based on a determination that the first set of primitive indices comprises at least one first primitive batch for the first graphics processing pass and that the second set of primitive indices comprises at least one second primitive batch for the second graphics processing pass. In yet another aspect, the control component 198 can be configured to switch the geometry processing from being used for the second graphics processing pass to being used for the first graphics processing pass at a primitive batch boundary for the at least one second primitive batch, the switch being triggered in response to a number of primitives associated with the second set of primitive indices stored in the GMEM being at least equal to a threshold. In an additional aspect, the control component 198 can be configured to: based on the number of primitives associated with the second set of primitive indices being stored in the GMEM being at least equal to the threshold, determine whether the second graphics processing pass is being performed prior to the primitive batch boundary of the at least one second primitive batch; control the geometry processor to perform the first graphics processing pass in response to the switch or beginning at the primitive batch boundary based on the determination; and control the second processor to perform the second graphics processing pass using the second data while the geometry processor performs the first graphics processing pass.

In some aspects, the control component 198 can also be configured to switch the geometry processor from being used for the first graphics processing pass to being used for the second graphics processing pass at a primitive batch boundary of the at least one first primitive batch, the switch being triggered in response to a number of primitives associated with the first set of primitive indices stored in the GMEM being less than or equal to a threshold, wherein the threshold is based on an amount of time incurred between: the switching of the geometry processor from being used for the first graphics processing pass to being used for the second graphics processing pass, and the storing of data output from the geometry processor into the GMEM following the switching. The control component 198 can also be configured to: based on the number of primitives associated with the first set of primitive indices being stored in the GMEM being less than or equal to the threshold, determine whether the first graphics processing pass is being performed prior to the primitive batch boundary of the at least one first primitive batch; and cause the geometry processor to perform the second graphics processing pass in response to the switch or beginning at the primitive batch boundary of the at least one first primitive batch based on the determination. In some aspects, the control component 198 can also be configured to: determine whether a number of primitives stored in the GMEM is less than an upper threshold and greater than a lower threshold, determine whether the geometry processor is currently performing the first graphics processing pass or the second graphics processing pass; and cause the geometry processor to continue performing the first graphics processing pass or the second graphics processing pass based on the determinations. Moreover, the control component 198 can be configured to control the GPU to: determine whether the first set of primitive indices does not comprise the at least one first primitive batch for the first graphics processing pass and whether the second set of primitive indices comprises the at least one second primitive batch for the second graphics processing pass, cause the geometry processor to perform the second graphics processing pass based on the determination.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component, e.g., a GPU, but, in further embodiments, can be performed using other components, e.g., a CPU, consistent with disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit that indicates which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

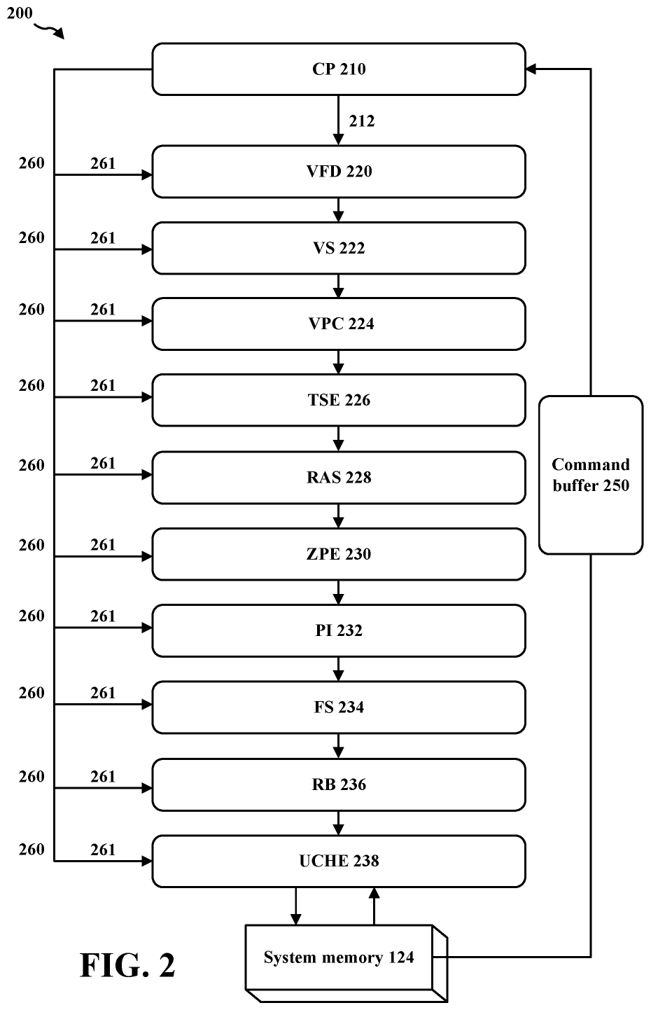

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 124. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

GPUs herein can process multiple types of data in a GPU pipeline. For instance, in some aspects, a GPU can process two types of data or data packets, e.g., context register packets and draw cell data. As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call packets 212 through separate paths to the processing units or blocks in the GPU. Further, the command buffer 250 can alternate different states of context registers and draw calls. For example, a command buffer can be structured in the following manner: context register of context N, draw call(s) of context N, context register of context N+1, and draw call(s) of context N+1.

GPUs can render images in a variety of different ways. In some instances, GPUs can render an image using rendering or tile rendering. In tiled rendering, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects, during a binning pass, an image can be divided into different bins or tiles. Moreover, in the binning pass, different primitives can be shaded in certain bins, e.g., using draw calls. In some aspects, during the binning pass, a visibility stream can be constructed where visible primitives or draw calls can be identified.

In some aspects, GPUs can apply the drawing or rendering process to different bins or tiles. For instance, a GPU can render to one bin, and then perform all the draws for the primitives or pixels in the bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a primitive visibility stream can be generated, e.g., in a binning pass, to determine the visibility information of each primitive in an image or scene. For instance, the primitive visibility stream can identify whether a certain primitive is visible or not. In some aspects, this information can be used to remove primitives that are not visible, e.g., in the rendering pass. Also, at least some of the primitives that are identified as visible can be rendered in the rendering pass.

Some types of GPUs or GPU architecture can support different types of tiled rendering such as tile based deferred rendering (TBDR). TBDR is a process that optimizes performance and power efficiency. TBDR can refer to rendering primitives or triangles one screen or bin at a time. As such, rendering can be performed on a bin-by-bin basis, until all the primitives or triangles have been rendered. In some aspects, GPUs operating TBDR can select a specific bin or area of an image, e.g., a rectangle, and render all of the primitives or triangles that fall into that bin or area. In some aspects of TBDR rendering, the potential rendering area can be divided in smaller tiles called bins such that certain data, e.g., depth and color data, can be present in on-chip graphics memory (GMEM). The rendering can then be performed one bin followed by next. In turn, this can reduce memory bandwidth and improve performance and power.

TBDR may be performed sequentially or concurrently. In some aspects of tiled rendering or TBDR, there can be multiple processing phases or passes. For instance, the TBDR process may happen in two passes, a tile sorting pass (also referred to as a bin visibility pass) and a tile render pass (also referred to as a bin rendering pass). The tile sorting pass checks the primitive visibility using a geometry processing pipe and is configured to sort the primitives into various bins and generate bin-level primitive visibility information. The tile render pass uses the bin-level primitive visibility information generated in a binning pass and renders screen space by taking one bin at a time using a geometry processing pipe and pixel processing pipe.

In another instance, the rendering can be performed in two passes, e.g., a visibility or bin visibility pass and a rendering or bin render pass. During a visibility pass, a GPU can input a rendering workload, record the positions of the primitives or triangles, and then determine which primitives or triangles fall into which bin or area. In some aspects of a visibility pass, GPU can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible As such, the primitives, or vertices of primitives, that are visible may be processed. By doing so, a GPU can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitives in each bin or area, e.g., in a system memory. This visibility information can be used to determine or generate a primitive visibility stream. In a rendering pass, the primitives in each bin can be rendered separately. In these instances, the primitive visibility stream can be fetched from memory used to drop primitives which are not visible for that bin.

In some aspects, TBDR in some GPU architecture may be supported in a concurrent binning (CB) scheme. In the CB scheme, the GPU begins the binning or bin visibility (BV) pass concurrently with bin rendering (BR) pass of a previous frame/render target. To accomplish this, separate bin visibility (or binning) pipe hardware is added to support the concurrency. In other words, dedicated geometry processing is needed for bin visibility generation in the CB architecture. The BV and BR pipes run in parallel with a BV pipe working on a subsequent frame while the BR pipe is working on a current frame. In the CB scheme, the best performance is achieved when the BV passes overlap or completely execute before the BR passes. In order to ensure that the CB scheme provides good performance per area (PPA) benefits, an area of dedicated BV pipe hardware is reduced by reducing BV pipe throughout and by reserving area intensive hardware (e.g., a shader processor) from bin render pipe for BV pipe operation.

However, the CB architecture has several drawbacks. First, additional geometry processing pipe for BV pass adds to a significant percentage of GPU area. Second, for downward scaling to low tier, the fixed area cost of BV pipe becomes a higher percentage of the overall GPU area and can result in PPA loss. Upward scaling to high tier requires an increase in BV pipe throughout so that the BV pass can be overlapped with the BR pass in additional areas, which can potentially result in PPA loss. Third, to reduce area overhead, dedicated BV pipe area intensive hardware functional blocks (e.g., a stream processor) from BR pipe are reserved for the BV pipe and cannot be used for BR pass operations. This fixed reservation of the stream processor can cause slowdown in BR pass and reducing overall performance and also does not provide scalable performance.

As mentioned above, in the bin render pass, most of the primitives are visible primitives as culled primitives are marked invisible in the visibility stream. For visible primitives, most of the workload show high pixel to triangle ratio. Due to this ratio, geometry processor is either stalled due to the highly loaded pixel processing pipe or is inactive.

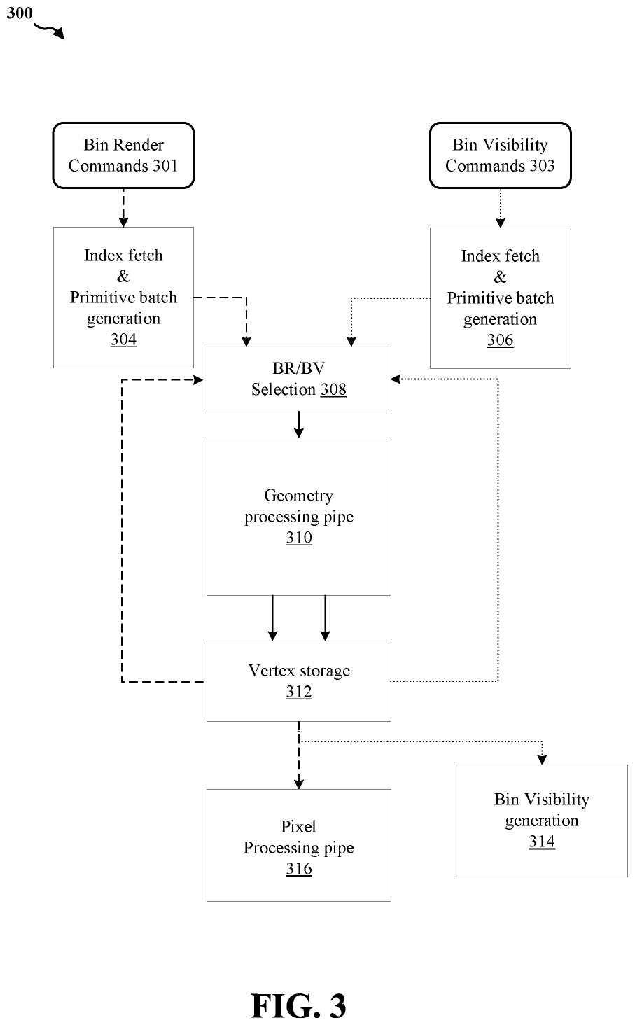

FIG. 3 illustrates an example architecture for performing a shared concurrent binning approach in accordance with one or more techniques of this disclosure. Specifically, FIG. 3 shows an example architecture 300 for sharing an underutilized BR geometry processing processor for a BR processing pass and BV processing pass. In contrast to having two dedicated geometry processing pipes, the example architecture 300 utilizes a single geometry processing pipe (geometry processor) that is time shared to perform either BR processing pass (as indicated by a dashed line) or the BV processing pass (as indicated by a dotted line).

As shown in FIG. 3, the example architecture 300 includes an index fetch & primitive batch generation stages 304, 306, BR/BV selection stage 308, a geometry processing pipe 310 (geometry processor), a vertex storage 312, a pixel processing pipe 316 (pixel processor), and a bin visibility generation stage 314 (performed by geometry processor). The example architecture 300 also includes bin render commands 301 and bin visibility commands 303.

In such an example architecture 300, the bin render commands 301 and bin visibility commands 303 are fed from separate commands processing and index fetching for the BV and BR pipeline so that the BV and BR pipeline can each concurrently proceed until index fetch (304 and 306). The bin render commands 301 and the bin visibility commands 303 are kept separate in order to keep the workload ready. The commands each generate a primitive batch for one frame. For example, one bin visibility command will generate a batch of primitives and visibility streams for one frame and one bin render command will generate a batch of primitives for pixel processing in one frame. Each of those primitive batches will be associated with a unique index and every command will have a one-to-one association. In addition, one command can have multiple primitive batches which can have multiple numbers of indices. After enough primitive batches (with associated index), those commands are received from a CPU and processed by a GPU.

The BR/BV selection stage 308 is responsible for selecting the BV and BR primitive indices from respective index fetch paths. This approach allows the geometry processing pipe 310 to be shared by both the BR processing pass and the BV processing pass while ensuring that one workload does not block progress of the other workload. To ensure that one workload does not impede the progress of the other, both the BV and BR output amount from a Geometry Processing Control (GPC) pipe is pre-calculated and allocated to be drained in an on-chip memory vertex storage. Accordingly, the BR pipe input to the pixel processing pipe 316 and the BV pipe input to the bin visibility generation stage 314 is sent from the vertex storage 312.

The selection of BR primitive indices or BV primitive indices for processing using time shared geometry processing pipe hardware is critical for improving performance. A workload selection algorithm may ensure that the pixel processing pipe 316 is not starved.

Since the geometry processing pipe 310 is being time shared for both BR and BV workload at a switch boundary, various caches in the geometry processing pipe 310 may be invalidated. This means that the switching granularity should be large enough such that it has a least impact on caches inside the geometry processing pipe 310 and overall performance. However, if the switching granularity is too large, it can result in a starvation of BR pixel slice since the BV workload is taking too long to reach a switch granularity point.

Accordingly, the example architecture 300 uses a primitive batch boundary as a BR/BV switching granularity. GPU optimization relies on the fact that the primitives are processed and connected sequentially and assembled sequentially. In order to prevent too much overhead and starvation of bin rendering or pixel processing, there should be a balance by using the primitive batch size as a switching granularity because the primitive batch size changes depending on bin rendering or bin visibility. The primitive batch is a group of consecutive quantity of primitives, where the quantity of primitives may be different for both the BR and BV pipe. Accordingly, the primitive batch boundary corresponds to a boundary associated with neighboring two primitive batches. As a non-limiting example, the BR primitive may have X primitives and the BV primitive batch may have Y primitives. In the example provided above, to achieve a proper balance, the X primitives may be double the Y primitives because BR is generally slower so BV should be smaller to avoid starvation.

In some aspects, BR workload also has most of the primitives visible because invisible primitives are removed in bin visibility pass. Workloads having higher pixel to triangle ratios exhibit more benefits from TBDR (e.g., two pass binning and bin render) and these workloads are submitted in concurrent binning mode. Due to the higher pixel to triangle ratio, bin-render pass and pixel processing pipe 316 take much more time to process a primitive batch as compared to the geometry processing pipe 310.

Although references to the different graphics processing passes are made in the context to allowing a bin render pass and a bin visibility pass to share a geometry processor, it should not be construed that the method in the example architecture 300 is limited to be used only for bin render commands and bin visibility commands. Instead, the example architecture 300 can be used for any other different combinations of graphics processing passes such as an immediate mode rendering pass, a remote rendering pass, shading pass, or the like.

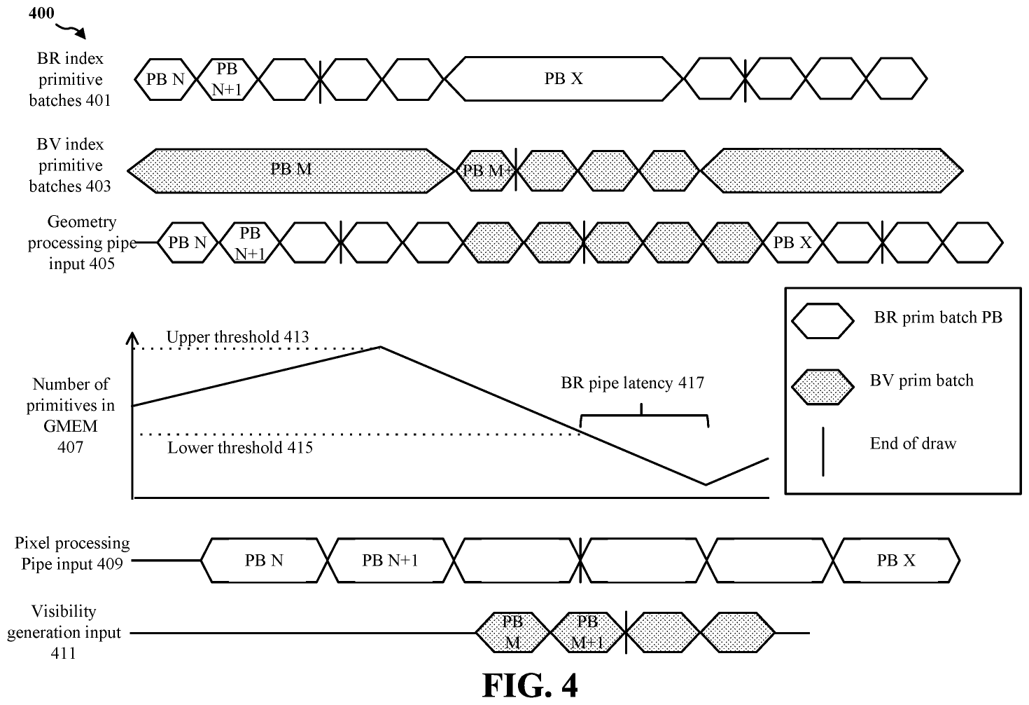

FIG. 4 illustrates an example diagram for graphics processing in accordance with one or more techniques of the disclosure. Specifically, FIG. 4 illustrates an example diagram 400 for sharing a geometry processing pipe using a watermarking scheme for selecting BR or BV.

As shown in FIG. 4, when both BR and BV primitive indices are ready to use the geometry processor, a selection algorithm selects one of them to use the geometry processor. In some aspects, the BR and BV primitive indices are considered ready to use when there is at least one set of primitive indices 401 for the BR processing pass and at least one set of primitive indices 403 for the BV processing pass. In diagram 400, BR is initially selected to use the geometry processing pipe 405 (the geometry processor). Due to a slow progression, pixel slice primitives are accumulated in the vertex storage (e.g., vertex storage 312 as shown in FIG. 3) and the selection algorithm is configured to track the number of primitives in the GMEM (e.g., vertex RAM) 407.

When the number of primitives in the GMEM reaches an upper threshold 413 (e.g., enough primitives are accumulated in the vertex GMEM to be used for bin rendering), the pixel processing pipe (the pixel processor) may work on those primitives from the GMEM and the geometry processing pipe can be used for BV workload. In other words, the upper threshold 413 indicates that there are enough polygons or vertices stored in the vertex storage such that pixel processing should continue and switch to BV on the geometry processing pipe. In this case, the pixel slice is not starved because there is work that BR can satisfy itself with in the meanwhile.

After reaching the upper threshold 413 of primitives in the vertex RAM, the selection algorithm uses geometry processing pipe for BV workload. In some aspects, the upper threshold 413 is determined based on a memory capacity associated with the BR processing pass. While the BV workload is getting processed in the geometry processing pipe, the BR pixel processing pipe continues to work on primitives from the vertex RAM, causing the number of primitives in GMEM to decrease. While the number of BR primitives in the GMEM is dropping towards the lower threshold 415, bin visibility (e.g., bin sorting) is occurring batch by batch.

When the BR primitives in the GMEM reach the lower threshold 415, the selection algorithm stops the BV workload at a primitive batch boundary and allows the BR workload to take over the geometry processing pipe. The lower threshold 415 indicates a point where if bin visibility (e.g., bin sorting) continues then there may be nothing left in the vertex storage for pixel processing (e.g., starvation). At the point of switch, the number of primitives in GMEM continues to decrease due to latency 417 involved between the polygons that are being generated in the graphics and in the actual rendering/pixel processing pipeline 409. As a result, more pixel processing will occur before the vertex storage begins to store more polygons and, thus, the number of primitives increases after the latency 417.

To that end, the lower threshold 415 is designed to accommodate latency 417. In some aspects, the latency is GPC BR pipe latency. After the switching occurs, drainage (e.g., decrease in the number of primitives in the GMEM) may continue to occur until the primitive data provided by the geometry processor are stored in the GMEM, after which the draining stops and the number of primitives increases back toward the upper threshold 413. In some aspects, the lower threshold 415 may be based on an amount of time incurred between a switching of the geometry processor from being used for BV processing pass to being used for the BR processing pass and the storing of data output from the geometry processor into the GMEM following the switching. In some aspects, the lower threshold 415 is determined based on the time it takes to drain the primitives to pixel slice allowing the BR workload to go through the geometry processing pipe and also be ready in vertex RAM for pixel pipe so that pixel pipe does not see any starvation.

As shown in FIG. 4, the BV processing pass can also be processed in the geometry processor in a shared manner with the BR processing pass without starving the pixel processing pipeline. This balanced approach of switching between the BR and BV allows the concurrent processing of bin rendering and bin visibility (or bin sorting primitives) without starvation effect.

The advantages of this process includes at least scalability and a BV/BR performance that is adaptive to workload. The architecture (e.g., example architecture 300 shown in FIG. 3) scales naturally both upward and download due to BV time-sharing the BR geometry processing pipe. In addition, both BV and BR can potentially achieve same geometry processing throughput and may change adaptively depending on the workload time-sharing of geometry processor. As there is no fixed reservation of hardware resources, the scheme also eliminates the performance shortcomings of existing CB schemes along with area benefits. The architecture also eliminates the need for software complexity to run binning pass on BR hardware because the BV pipe throughput is adaptively adjusted depending on workload to ensure that the binning workload execution completely overlaps with BR.

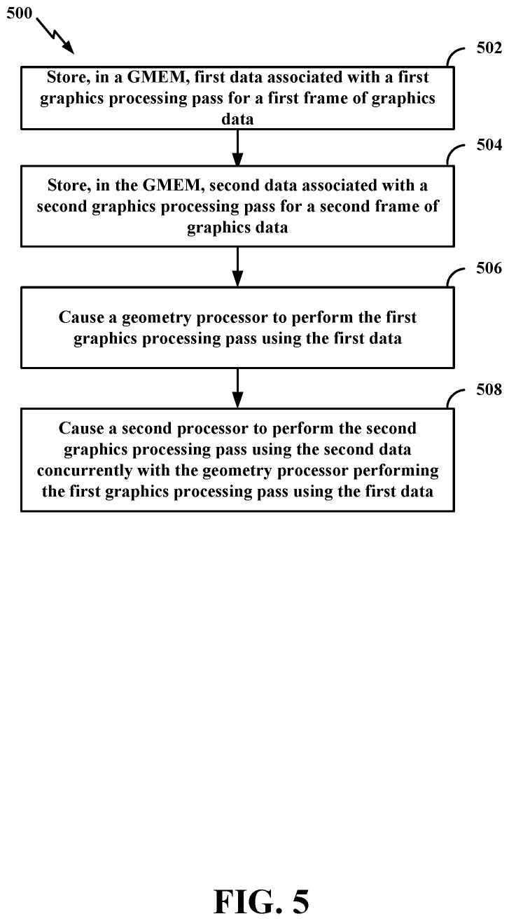

FIG. 5 shows an example flowchart illustrating an example method 500 for graphic processing in accordance with one or more techniques of this disclosure. The method 500 may be performed by an apparatus, such as control component 198, as described above. In some implementations, the method 500 is performed by processing logic, including hardware, firmware, software, or a combination thereof. In some implementations, the method 500 is performed by a processor executing code stored in a non-transitory computer-readable medium (e.g., a memory).

At block 502, the method 500 includes storing, in a GMEM, first data associated with a first graphics processing pass for a first frame of graphics data. At block 504, the method 500 includes storing, in the GMEM, second data associated with a second graphics processing pass for a second frame of graphics data. In an aspect, the first graphics processing pass may be a bin visibility pass and the second graphics processing pass may be a bin rendering pass. In another aspect, the first graphics processing pass may be a bin rendering pass and the second graphics processing pass may be a bin visibility pass. In some other aspects, the first graphics processing pass may be a first bin rendering pass and the second graphics processing pass may be a second bin rendering pass. In other aspects, the first frame is a current frame and the second frame is a subsequent frame. In some aspects, the first graphics processing pass may be a bin rendering pass or a bin visibility pass, and the second graphics processing pass may be an immediate mode rendering pass. In other aspects, the first graphics processing pass may be an immediate mode rendering pass, and the second graphics processing pass may be a bin rendering pass or a bin visibility pass.

At block 506, the method 500 includes causing a geometry processor to perform the first graphics processing pass using the first data. At block 508, the method 500 includes causing a second processor to perform the second graphics processing pass using the second data concurrently with the geometry processor performing the first graphics processing pass using the first data. In some aspects, the first graphics processing pass and the second graphics processing pass may share the geometry processor. In some aspects, the second processor corresponds to a pixel processor.

In some aspects, the first set of primitive indices in the at least one first primitive batch for the first graphics processing pass may comprise a first quantity of indices and the second set of primitive indices in the at least one second primitive batch for the second graphics processing pass may comprise a second quantity of indices. In some aspects, the first quantity of indices may be different than the second quantity of indices.

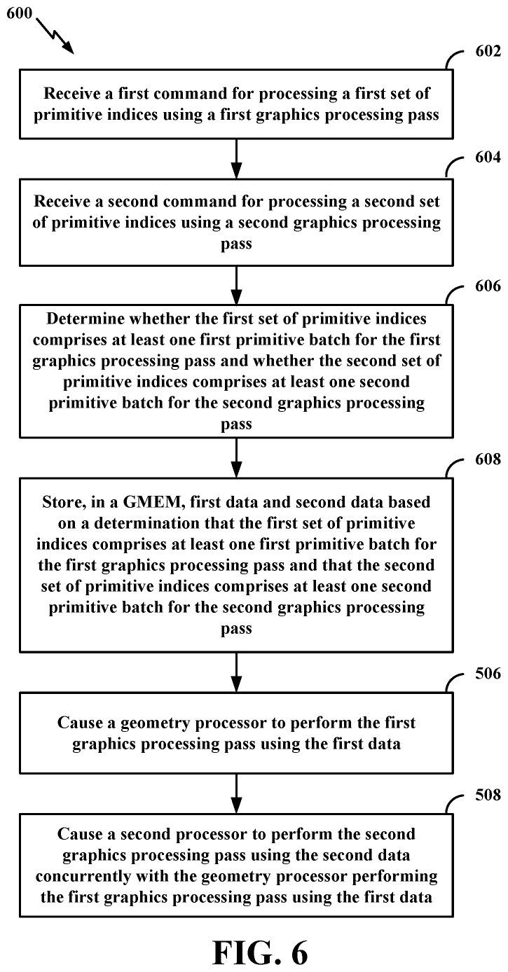

FIG. 6 shows an example flowchart illustrating an example method 600 for graphic processing in accordance with one or more techniques of this disclosure. The method 600 may be performed by an apparatus, such as control component 198, as described above. In some implementations, the method 600 is performed by processing logic, including hardware, firmware, software, or a combination thereof. In some implementations, the method 600 is performed by a processor executing code stored in a non-transitory computer-readable medium (e.g., a memory). In such methods 600, blocks 506 and 508 are performed as described above in connection to FIG. 5.

At block 602, the method 600 includes receiving a first command for processing a first set of primitive indices using a first graphics processing pass. At block 604, the method 600 includes receiving a second command for processing a second set of primitive indices using a second graphics processing pass.

At block 606, the method 600 includes determining whether the first set of primitive indices comprises at least one first primitive batch for the first graphics processing pass and whether the second set of primitive indices comprises at least one second primitive batch for the second graphics processing pass.

At block 608, the method 600 includes storing, in a GMEM, first data and second data based on a determination that the first set of primitive indices comprises at least one first primitive batch for the first graphics processing pass and that the second set of primitive indices comprises at least one second primitive batch for the second graphics processing pass. In some aspects, the first data may comprise primitives associated with the first set of primitive indices and the second data may comprise primitives associated with the second set of primitive indices.

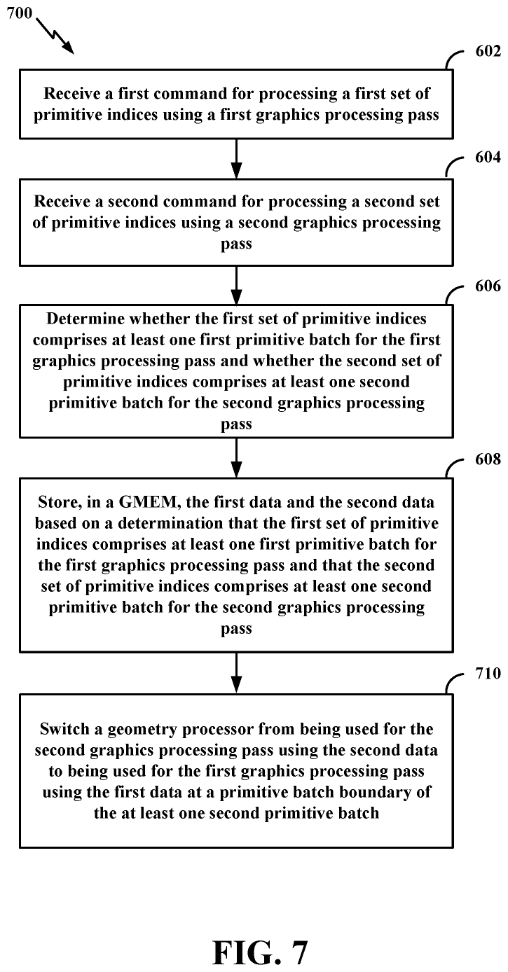

FIG. 7 shows an example flowchart illustrating an example method 700 for graphic processing in accordance with one or more techniques of this disclosure. The method 700 may be performed by an apparatus, such as control component 198, as described above. In some implementations, the method 700 is performed by processing logic, including hardware, firmware, software, or a combination thereof. In some implementations, the method 700 is performed by a processor executing code stored in a non-transitory computer-readable medium (e.g., a memory). In such methods 700, block 602, block 604, block 606, and block 608 are performed as described above in connection to FIG. 6.

At block 710, the method 700 includes switching a geometry processor from being used for the second graphics processing pass to being used for the first graphics processing pass at a primitive batch boundary of the at least one second primitive batch. In some aspects, the switch may be triggered in response to a number of primitives associated with the second set of primitive indices stored in the GMEM being at least equal to a threshold. In other aspects, the threshold may be based on a memory capacity associated with the second graphics processing pass.

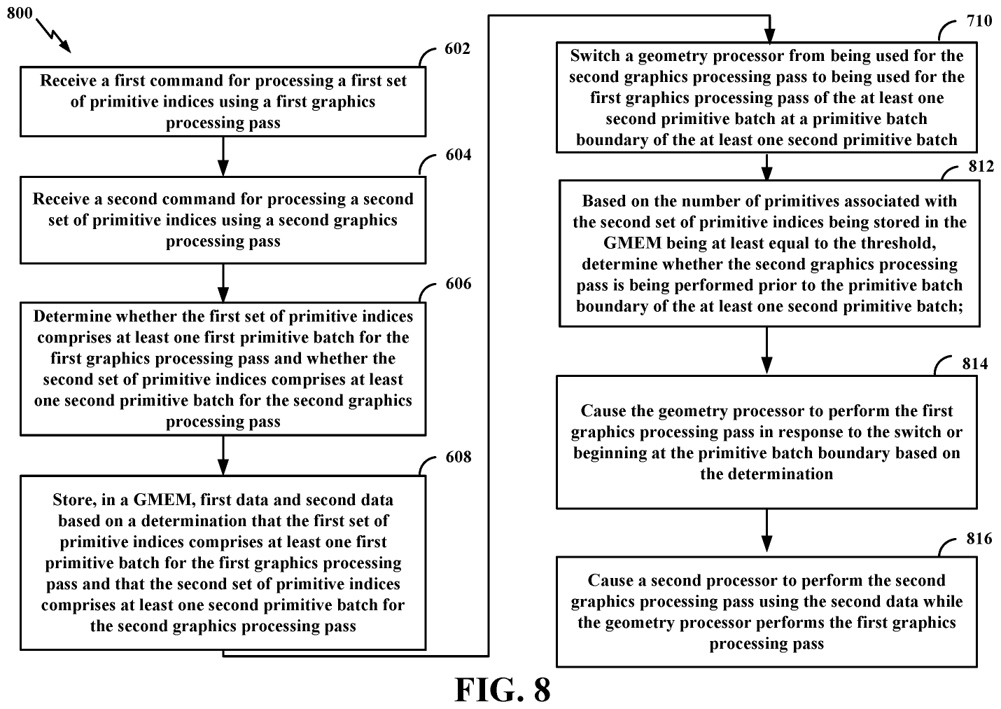

FIG. 8 shows an example flowchart illustrating an example method 800 for graphic processing in accordance with one or more techniques of this disclosure. The method 800 may be performed by an apparatus, such as control component 198, as described above. In some implementations, the method 800 is performed by processing logic, including hardware, firmware, software, or a combination thereof. In some implementations, the method 800 is performed by a processor executing code stored in a non-transitory computer-readable medium (e.g., a memory). In such methods 800, block 602, block 604, block 606, and block 608 are performed as described above in connection to FIG. 6 and block 710 is performed as described above in connection to FIG. 7.

At block 812, the method 800 includes based on the number of primitives associated with the second set of primitive indices being stored in the GMEM being at least equal to the threshold, determining whether the second graphics processing pass is being performed prior to the primitive batch boundary of the at least one second primitive batch.

At block 814, the method 800 includes causing the geometry processor to perform the first graphics processing pass in response to the switch or beginning at the primitive batch boundary based on the determination.

At block 816, the method 800 includes causing a second processor to perform the second graphics processing pass using the second data while the geometry processor performs the first graphics processing pass. In some aspects, the second processor corresponds to a pixel processor.

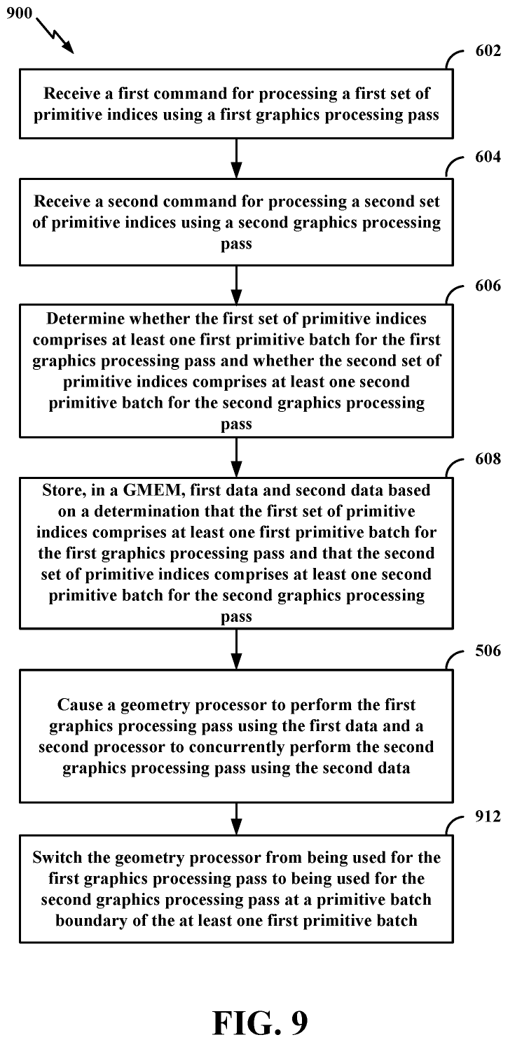

FIG. 9 shows an example flowchart illustrating an example method 900 for graphic processing in accordance with one or more techniques of this disclosure. The method 900 may be performed by an apparatus, such as control component 198, as described above. In some implementations, the method 900 is performed by processing logic, including hardware, firmware, software, or a combination thereof. In some implementations, the method 900 is performed by a processor executing code stored in a non-transitory computer-readable medium (e.g., a memory). In such methods 900, block 602, block 604, block 606, and block 608 are performed as described above in connection to FIG. 6 and block 506 is performed as described above in connection to FIG. 5.

At block 912, the method 900 includes switching the geometry processor from being used for the first graphics processing pass to being used for the second graphics processing pass at a primitive batch boundary of the at least one first primitive batch. In some aspects, the switch may be triggered in response to a number of primitives associated with the first set of primitive indices stored in the GMEM being less than or equal to a threshold. In other aspects, the threshold may be based on an amount of time incurred between the switching of the geometry processor from being used for the first graphics processing pass to being used for the second graphics processing pass, and the storing of data output from the geometry processor into the GMEM following the switching.

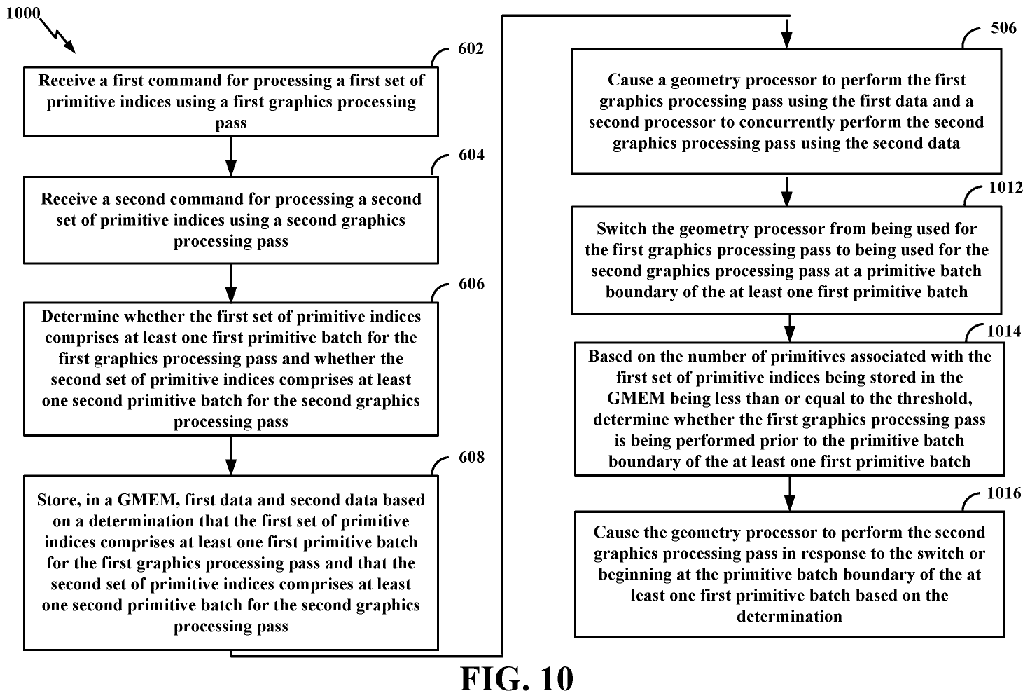

FIG. 10 shows an example flowchart illustrating an example method 1000 for graphic processing in accordance with one or more techniques of this disclosure. The method 1000 may be performed by an apparatus, such as control component 198, as described above. In some implementations, the method 1000 is performed by processing logic, including hardware, firmware, software, or a combination thereof. In some implementations, the method 1000 is performed by a processor executing code stored in a non-transitory computer-readable medium (e.g., a memory). In such methods 1000, block 602, block 604, block 606, and block 608 are performed as described above in connection to FIG. 6 and block 506 is performed as described above in connection to FIG. 5.

At block 1012, the method 1000 includes switching the geometry processor from being used for the first graphics processing pass to being used for the second graphics processing pass at a primitive batch boundary of the at least one first primitive batch. In some aspects, the switch may be triggered in response to a number of primitives associated with the first set of primitive indices stored in the GMEM being less than or equal to a threshold. In other aspects, the threshold may be based on an amount of time incurred between the switching of the geometry processor from being used for the first graphics processing pass to being used for the second graphics processing pass, and the storing of data output from the geometry processor into the GMEM following the switching.

At block 1014, the method 1000 includes based on the number of primitives associated with the first set of primitive indices being stored in the GMEM being less than or equal to the threshold, determining whether the first graphics processing pass is being performed prior to the primitive batch boundary of the at least one first primitive batch.

At block 1016, the method 1000 includes causing the geometry processor to perform the second graphics processing pass in response to the switch or beginning at the primitive batch boundary of the at least one first primitive batch based on the determination.

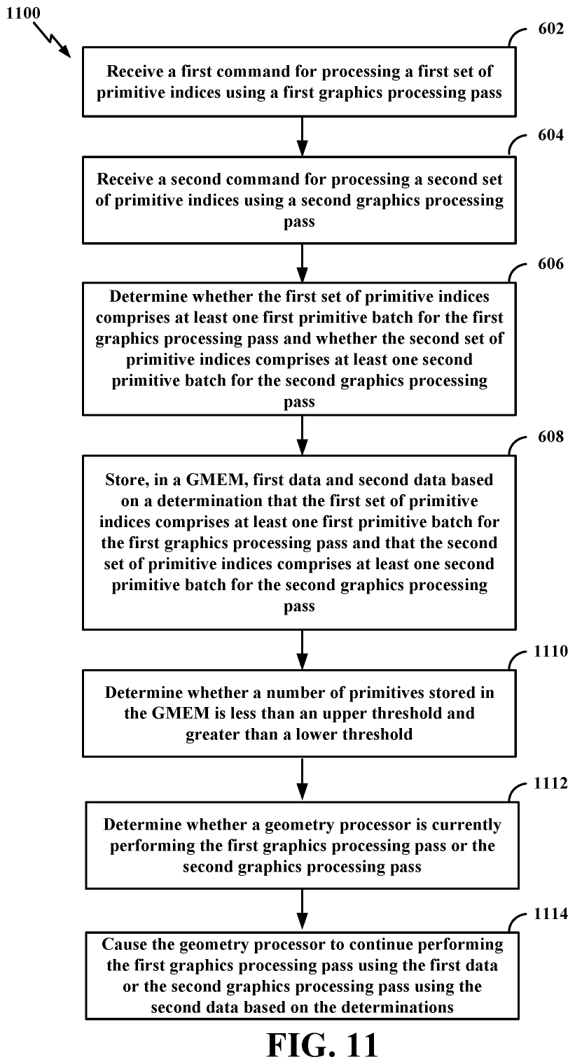

FIG. 11 shows an example flowchart illustrating an example method 1100 for graphic processing in accordance with one or more techniques of this disclosure. The method 1100 may be performed by an apparatus, such as control component 198, as described above. In some implementations, the method 1100 is performed by processing logic, including hardware, firmware, software, or a combination thereof. In some implementations, the method 1100 is performed by a processor executing code stored in a non-transitory computer-readable medium (e.g., a memory). In such methods 1100, block 602, block 604, block 606, and block 608 are performed as described above in connection to FIG. 6.

At block 1110, the method 1100 includes determining whether a number of primitives stored in the GMEM is less than an upper threshold and greater than a lower threshold. In some aspects, the upper threshold is based on a memory capacity associated with the BV processing pass. In some aspects, the lower threshold is based on an amount of time incurred between the switching of the geometry processor from being used for the BV processing pass to being used for the BR processing pass and the storing of data output from the geometry processor into a GMEM following the switch.

At block 1112, the method 1100 includes determining whether the geometry processor is currently performing the first graphics processing pass or the second graphics processing pass.

At block 1114, the method 1100 includes causing the geometry processor to continue performing the first graphics processing pass or the second graphics processing pass based on the determinations.

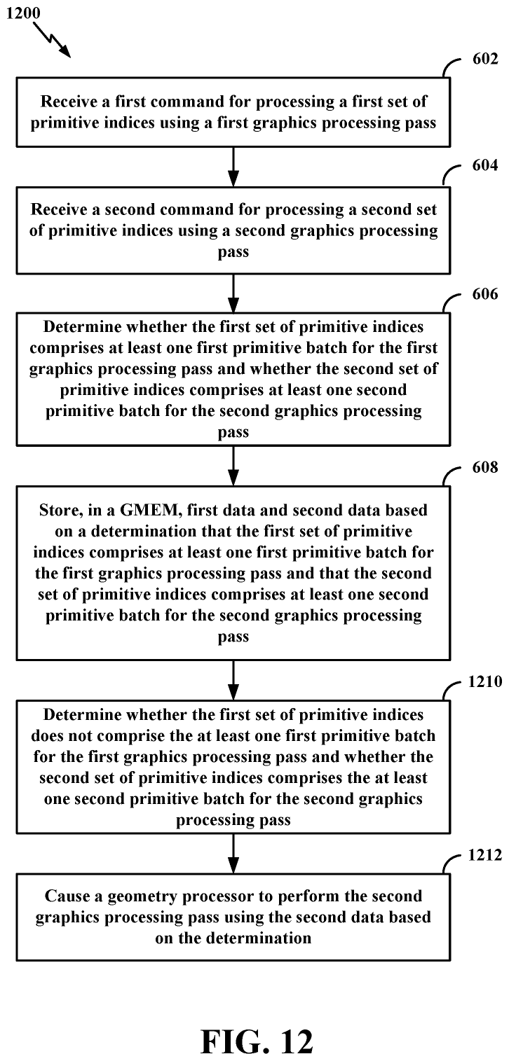

FIG. 12 shows an example flowchart illustrating an example method 1200 for graphic processing in accordance with one or more techniques of this disclosure. The method 1200 may be performed by an apparatus, such as control component 198, as described above. In some implementations, the method 1200 is performed by processing logic, including hardware, firmware, software, or a combination thereof. In some implementations, the method 1200 is performed by a processor executing code stored in a non-transitory computer-readable medium (e.g., a memory). In such methods 1200, block 602, block 604, block 606, and block 608 are performed as described above in connection to FIG. 6.

At block 1210, the method 1200 includes determining whether the first set of primitive indices does not comprise the at least one first primitive batch for the first graphics processing pass and whether the second set of primitive indices comprises the at least one second primitive batch for the second graphics processing pass.

At block 1212, the method 1200 includes causing the geometry processor to perform the second graphics processing pass based on the determination.

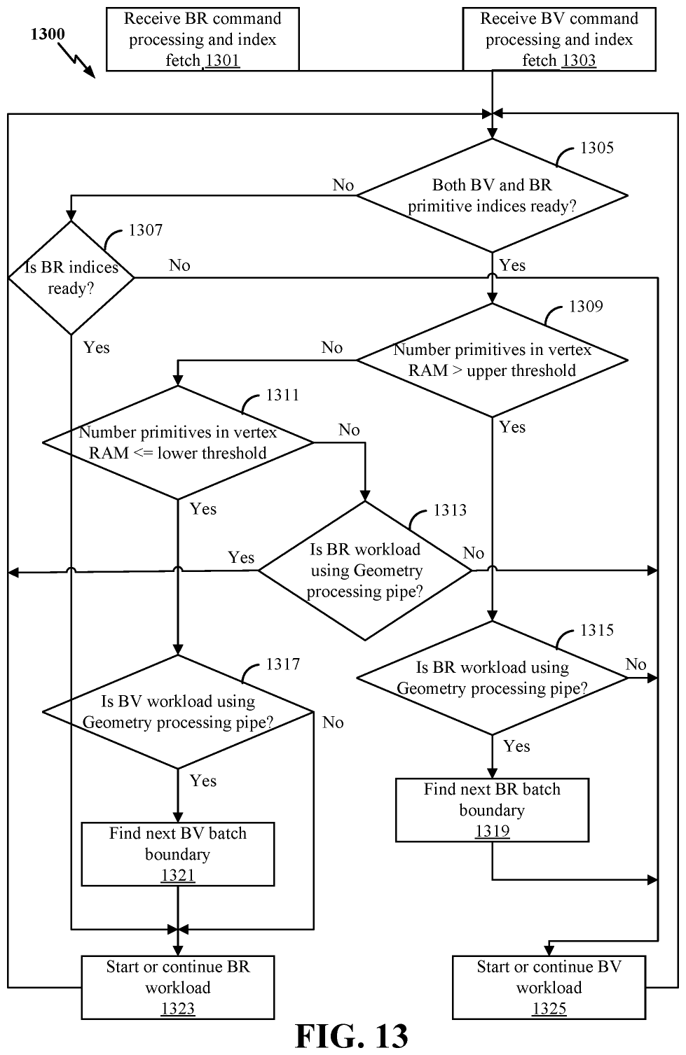

FIG. 13 shows an example flowchart illustrating an example method 1300 for graphic processing in accordance with one or more techniques of this disclosure. The method 1300 may be performed by an apparatus, such as control component 198, as described above. In some implementations, the method 1300 is performed by processing logic, including hardware, firmware, software, or a combination thereof. In some implementations, the method 1300 is performed by a processor executing code stored in a non-transitory computer-readable medium (e.g., a memory).

As represented by block 1301, the method 1300 includes receiving a BR command processing and index fetch. As represented by block 1303, the method 1300 includes receiving a BV command processing and index fetch.

As represented by block 1305, the method 1300 includes determining whether the BV and BR primitive indices are ready. As discussed above, the BV and BR primitive indices are ready when the first set of primitive indices comprises at least one first primitive batch for the BV processing pass and the second set of primitive indices comprises at least one second primitive batch for the BR processing pass. If both BV and BR primitive indices are not ready, then, as represented by block 1307, the method 1300 includes determining whether the BR primitive indices are ready. If the BV and BR primitive indices are ready, then, as represented by block 1309, the method 1300 includes determining whether a number of primitives in a vertex RAM is greater than an upper threshold. In some aspects, the upper threshold is based on a memory capacity associated with the BV processing pass.

If the number of primitives in the vertex RAM is greater than the upper threshold, then, as represented by block 1315, the method 1300 includes determining whether the BR workload is using a geometry processing pipeline. If the number of primitives in the vertex RAM is not greater than the upper threshold, then, as represented by block 1311, the method 1300 includes determining whether the number of primitives in the vertex RAM is less than or equal to a lower threshold. In some aspects, the lower threshold is based on an amount of time incurred between the switching of the geometry processor from being used for the BV processing pass to being used for the BR processing pass and the storing of data output from the geometry processor into a GMEM following the switch.

If the BR workload is using the geometry processing pipe, then, as represented by blocks 1319 and 1325, the method 1300 includes finding a next BR batch boundary and starting or continuing the BR workload. As represented by block 1305, the method 1300 includes returning to determining whether both BV and BR primitive indices are ready. If the BR workload is not using the geometry processing pipe, then, as represented by block 1325, the method 1300 includes starting or continuing the BV workload. As represented by block 1305, the method 1300 includes returning to determining whether both BV and BR primitive indices are ready.

If the number of primitives in the vertex RAM is less than or equal to the lower threshold, then, as represented by the block 1317, the method 1300 includes determining whether the BV workload is using the geometry processing pipe. If the BV workload is not using the geometry processing pipe, then, as represented by block 1323, the method 1300 includes starting or continuing the BR workload. As represented by block 1305, the method 1300 includes returning to determining whether both BV and BR primitive indices are ready. If the BV workload is using the geometry processing pipe, then, as represented by block 1321, the method 1300 includes finding a next BV batch boundary and, as represented by block 1323, starting or continuing the BR workload. As represented by block 1305, the method 1300 includes returning to determining whether both BV and BR primitive indices are ready.

If the number of primitives in the vertex RAM is not less than or equal to the lower threshold then, as represented by block 1313, the method 1300 includes determining whether the BR workload is using the geometry processing pipe. If the BR workload is not using the geometry processing pipe, then, as represented by block 1325, the method 1300 includes starting or continuing the BV workload. If the BR workload is using the geometry processing pipe, then, as represented by block 1323, the method 1300 includes starting or continuing the BR workload. As represented by block 1305, the method 1300 includes returning to determining whether both BV and BR primitive indices are ready.

The subject matter described herein can be implemented to realize one more benefits or advantages. For instance, the techniques disclosed herein enable the GPU 120 to utilize sharing a geometry processor between two graphics processing passes to implement a shared concurrent binning approach. As a result, compared to other concurrent binning approaches, the GPU does not require an additional dedicated geometry processor for performing the two graphic processing passes. In addition, since the BV pipe throughput is adaptively adjusted depending on workload to ensure that the binning workload execution is completely overlapped with BR, this also eliminates the need for software complexity to run binning processing pass on BR hardware.

The subject matter described herein can be implemented to realize one or more benefits or advantages. For instance, the described graphics processing techniques can be used by a server, a client, a GPU, a CPU, or some other processor that can perform computer or graphics processing to implement the sharing techniques described herein. This can also be accomplished at a low cost compared to other computer or graphics processing techniques. Moreover, the computer or graphics processing techniques herein can improve or speed up data processing or execution. Further, the computer or graphics processing techniques herein can improve resource or data utilization and/or resource efficiency.

### Some Additional Examples

The aspects described herein additionally include one or more of the following implementation examples described in the following numbered clauses.

Example 1 is an apparatus for graphics processing, that is configured for: storing, in a GMEM, first data associated with a first graphics processing pass for a first frame of graphics data; storing, in the GMEM, second data associated with a second graphics processing pass for a second frame of graphics data; causing the geometry processor to perform the first graphics processing pass using the first data; and causing the second processor to perform the second graphics processing pass using the second data concurrently with the geometry processor performing the first graphics processing pass using the first data.

Example 2 may be the apparatus of Example 1, and being further configured for: receiving a first command for processing a first set of primitive indices using the first graphics processing pass; receiving a second command for processing a second set of primitive indices using the second graphics processing pass; determining whether the first set of primitive indices comprises at least one first primitive batch for the first graphics processing pass and whether the second set of primitive indices comprises at least one second primitive batch for the second graphics processing pass; and causing a GPU to store, in a GMEM, the first data and the second data based on a determination that the first set of primitive indices comprises at least one first primitive batch for the first graphics processing pass and that the second set of primitive indices comprises at least one second primitive batch for the second graphics processing pass, and the first data comprises primitives being associated with the first set of primitive indices and the second data comprises being primitives associated with the second set of primitive indices.

Example 3 may be the apparatus of Example 2, and being further configured for: switching the geometry processor from being used for the second graphics processing pass to being used for the first graphics processing pass at a primitive batch boundary of the at least one second primitive batch, the switch being triggered in response to a number of primitives associated with the second set of primitive indices stored in the GMEM being at least equal to a threshold, and the threshold being based on a memory capacity associated with the second graphics processing pass.

Example 4 may be the apparatus of Example 3, and being further configured for: based on the number of primitives associated with the second set of primitive indices being stored in the GMEM being at least equal to the threshold, determining whether the second graphics processing pass is being performed prior to the primitive batch boundary of the at least one second primitive batch; causing the geometry processor to perform the first graphics processing pass in response to the switch or beginning at the primitive batch boundary based on the determination; and causing the pixel processor to perform the second graphics processing pass using the second data while the geometry processor performs the first graphics processing pass.

Example 5 may be the apparatus of Example 2, and further being configured for: switching the geometry processor from being used for the first graphics processing pass to being used for the second graphics processing pass at a primitive batch boundary of the at least one first primitive batch, the switch being triggered in response to a number of primitives associated with the first set of primitive indices stored in the GMEM being less than or equal to a threshold, and the threshold being based on an amount of time incurred between: the switching of the geometry processor from being used for the first graphics processing pass to being used for the second graphics processing pass, and the storing of data output from the geometry processor into the GMEM following the switching.

Example 6 may be the apparatus of Example 5, and further being configured for: based on the number of primitives associated with the first set of primitive indices being stored in the GMEM being less than or equal to the threshold, determining whether the first graphics processing pass is being performed prior to the primitive batch boundary of the at least one first primitive batch; and causing the geometry processor to perform the second graphics processing pass in response to the switch or beginning at the primitive batch boundary of the at least one first primitive batch based on the determination.

Example 7 may be the apparatus of Example 2, and further being configured for: determining whether a number of primitives stored in the GMEM is less than an upper threshold and greater than a lower threshold; determining whether the geometry processor is currently performing the first graphics processing pass or the second graphics processing pass; and causing the geometry processor to continue performing the first graphics processing pass or the second graphics processing pass based on the determinations.

Example 8 may be the apparatus of Example 2, and further being configured for: determining whether the first set of primitive indices does not comprise the at least one first primitive batch for the first graphics processing pass and whether the second set of primitive indices comprises the at least one second primitive batch for the second graphics processing pass; and causing the geometry processor to perform the second graphics processing pass based on the determination.

Example 9 may be the apparatus of Example 2, and the first set of primitive indices in the at least one first primitive batch for the first graphics processing pass comprising a first quantity of indices and the second set of primitive indices in the at least one second primitive batch for the second graphics processing pass comprising a second quantity of indices, the first quantity of indices being different than the second quantity of indices.

Example 10 may be the apparatus of Example 1, and the first graphics processing pass being a bin visibility pass and the second graphics processing pass being a bin rendering pass.

Example 11 may be the apparatus of Example 1, and the first graphics processing pass being a bin rendering pass and the second graphics processing pass being a bin visibility pass.

Example 12 may be the apparatus of Example 1, and the first graphics processing pass being a first bin rendering pass and the second graphics processing pass being a second bin rendering pass.

Example 13 may be the apparatus of Example 1, and the first graphics processing pass being a bin visibility pass for a current frame and the second graphics processing pass being a bin visibility pass for a subsequent frame.

Example 14 may be the apparatus of Example 1, and the first graphics processing pass being a bin rendering pass or a bin visibility pass, and the second graphics processing pass being an immediate mode rendering pass.

Example 15 may be the apparatus of Example 1, and the first graphics processing pass being an immediate mode rendering pass, and the second graphics processing pass being a bin rendering pass or a bin visibility pass.

Example 16 may be an apparatus of Example 1, and the second processor corresponding to a pixel processor.

Example 17 may be an apparatus of Example 1, and the at least one processor further comprising a CPU and a GPU.

In accordance with this disclosure, the term “or” may be interrupted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware.

What is claimed is:

1. An apparatus for graphics processing, comprising:
a memory; and
at least one processor comprising:
a graphics memory (GMEM),
a geometry processor coupled to the GMEM, and
a second processor coupled to the GMEM,
wherein the at least one processor is coupled to the memory and, based at least in part on information stored in the memory, is configured to:
store, in the GMEM, first data associated with a first graphics processing pass for a first frame of graphics data;
store, in the GMEM, second data associated with a second graphics processing pass for a second frame of graphics data;
cause the geometry processor to perform the first graphics processing pass using the first data; and
cause the second processor to perform the second graphics processing pass using the second data concurrently with the geometry processor performing the first graphics processing pass using the first data, wherein the first graphics processing pass and the second graphics processing pass share the geometry processor.

2. The apparatus of claim 1, wherein the at least one processor is further configured to:
receive a first command for processing a first set of primitive indices using the first graphics processing pass;
receive a second command for processing a second set of primitive indices using the second graphics processing pass;
determine whether the first set of primitive indices comprises at least one first primitive batch for the first graphics processing pass and whether the second set of primitive indices comprises at least one second primitive batch for the second graphics processing pass; and
store, in the GMEM, the first data and the second data based on a determination that the first set of primitive indices comprises at least one first primitive batch for the first graphics processing pass and that the second set of primitive indices comprises at least one second primitive batch for the second graphics processing pass,
wherein the first data comprises primitives associated with the first set of primitive indices and the second data comprises primitives associated with the second set of primitive indices.

3. The apparatus of claim 2, wherein the at least one processor is further configured to:
switch the geometry processor from being used for the second graphics processing pass to being used for the first graphics processing pass at a primitive batch boundary of the at least one second primitive batch, the switch being triggered in response to a number of primitives associated with the second set of primitive indices stored in the GMEM being at least equal to a threshold,
wherein the threshold is based on a memory capacity associated with the second graphics processing pass.

4. The apparatus of claim 3, wherein the at least one processor is further configured to:
based on the number of primitives associated with the second set of primitive indices being stored in the GMEM being at least equal to the threshold, determine whether the second graphics processing pass is being performed prior to the primitive batch boundary of the at least one second primitive batch;
cause the geometry processor to perform the first graphics processing pass in response to the switch or beginning at the primitive batch boundary based on the determination; and
cause the second processor to perform the second graphics processing pass using the second data while the geometry processor performs the first graphics processing pass.

5. The apparatus of claim 2, wherein the at least one processor is further configured to:
switch the geometry processor from being used for the first graphics processing pass to being used for the second graphics processing pass at a primitive batch boundary of the at least one first primitive batch, the switch being triggered in response to a number of primitives associated with the first set of primitive indices stored in the GMEM being less than or equal to a threshold,
wherein the threshold is based on an amount of time incurred between:
the switching of the geometry processor from being used for the first graphics processing pass to being used for the second graphics processing pass, and
the storing of data output from the geometry processor into the GMEM following the switching.

6. The apparatus of claim 5, wherein the at least one processor is further configured to:
based on the number of primitives associated with the first set of primitive indices being stored in the GMEM being less than or equal to the threshold, determine whether the first graphics processing pass is being performed prior to the primitive batch boundary of the at least one first primitive batch; and
cause the geometry processor to perform the second graphics processing pass in response to the switch or beginning at the primitive batch boundary of the at least one first primitive batch based on the determination.

7. The apparatus of claim 2, wherein the at least one processor is further configured to:
determine whether a number of primitives stored in the GMEM is less than an upper threshold and greater than a lower threshold;
determine whether the geometry processor is currently performing the first graphics processing pass or the second graphics processing pass; and
cause the geometry processor to continue performing the first graphics processing pass or the second graphics processing pass based on the determinations.

8. The apparatus of claim 2, wherein the at least one processor is further configured to:
determine whether the first set of primitive indices does not comprise the at least one first primitive batch for the first graphics processing pass and whether the second set of primitive indices comprises the at least one second primitive batch for the second graphics processing pass; and
cause the geometry processor to perform the second graphics processing pass based on the determination.

9. The apparatus of claim 2, wherein the first set of primitive indices in the at least one first primitive batch for the first graphics processing pass comprises a first quantity of indices and the second set of primitive indices in the at least one second primitive batch for the second graphics processing pass comprises a second quantity of indices, the first quantity of indices being different than the second quantity of indices.

10. The apparatus of claim 1, wherein the first graphics processing pass is a bin visibility pass and the second graphics processing pass is a bin rendering pass.

11. The apparatus of claim 1, wherein the first graphics processing pass is a bin rendering pass and the second graphics processing pass is a bin visibility pass.

12. The apparatus of claim 1, wherein the first graphics processing pass is a first bin rendering pass and the second graphics processing pass is a second bin rendering pass.

13. The apparatus of claim 1, wherein for the first frame is a current frame and the second frame is a subsequent frame.

14. The apparatus of claim 1, wherein the first graphics processing pass is a bin rendering pass or a bin visibility pass, and the second graphics processing pass is an immediate mode rendering pass.

15. The apparatus of claim 1, wherein the first graphics processing pass is an immediate mode rendering pass, and the second graphics processing pass is a bin rendering pass or a bin visibility pass.

16. The apparatus of claim 1, wherein the second processor corresponds to a pixel processor.

17. The apparatus of claim 1, wherein the at least one processor further comprises a central processing unit (CPU) and a graphics processing unit (GPU).

18. A method for graphics processing, comprising:
storing, in a graphics memory (GMEM), first data associated with a first graphics processing pass for a first frame of graphics data;
storing, in the GMEM, second data associated with a second graphics processing pass for a second frame of graphics data;
causing a geometry processor to perform the first graphics processing pass using the first data; and
causing a second processor to perform the second graphics processing pass using the second data concurrently with the geometry processor performing the first graphics processing pass using the first data, wherein the first graphics processing pass and the second graphics processing pass share the geometry processor.

19. The method of claim 18, further comprising:
receiving a first command for processing a first set of primitive indices using the first graphics processing pass;
receiving a second command for processing a second set of primitive indices using the second graphics processing pass;
determining whether the first set of primitive indices comprises at least one first primitive batch for the first graphics processing pass and whether the second set of primitive indices comprises at least one second primitive batch for the second graphics processing pass; and
storing, in the GMEM, the first data and the second data based on a determination that the first set of primitive indices comprises at least one first primitive batch for the first graphics processing pass and that the second set of primitive indices comprises at least one second primitive batch for the second graphics processing pass,
wherein the first data comprises primitives associated with the first set of primitive indices and the second data comprises primitives associated with the second set of primitive indices.

20. The method of claim 19, further comprising:
switching the geometry processor from being used for the second graphics processing pass to being used for the first graphics processing pass at a primitive batch boundary of the at least one second primitive batch, the switch being triggered in response to a number of primitives associated with the second set of primitive indices stored in the GMEM being at least equal to a threshold,
wherein the threshold is based on a memory capacity associated with the second graphics processing pass.

21. The method of claim 20, further comprising:
based on the number of primitives associated with the second set of primitive indices being stored in the GMEM being at least equal to the threshold,
determining whether the second graphics processing pass is being performed prior to the primitive batch boundary of the at least one second primitive batch;
causing the geometry processor to perform the first graphics processing pass in response to the switch or beginning at the primitive batch boundary based on the determination; and
causing the second processor to perform the second graphics processing pass using the second data while the geometry processor performs the first graphics processing pass.

22. The method of claim 19, further comprising:
switching the geometry processor from being used for the first graphics processing pass to being used for the second graphics processing pass at a primitive batch boundary of the at least one first primitive batch, the switch being triggered in response to a number of primitives associated with the first set of primitive indices stored in the GMEM being less than or equal to a threshold,
wherein the threshold is based on an amount of time incurred between:
the switching of the geometry processor from being used for the first graphics processing pass to being used for the second graphics processing pass, and
the storing of data output from the geometry processor into the GMEM following the switching.

23. The method of claim 22, further comprising:
based on the number of primitives associated with the first set of primitive indices being stored in the GMEM being less than or equal to the threshold,
determining whether the first graphics processing pass is being performed prior to the primitive batch boundary of the at least one first primitive batch; and
causing the geometry processor to perform the second graphics processing pass in response to the switch or beginning at the primitive batch boundary of the at least one first primitive batch based on the determination.

24. The method of claim 19, further comprising:
determining whether a number of primitives stored in the GMEM is less than an upper threshold and greater than a lower threshold,
determining whether the geometry processor is currently performing the first graphics processing pass or the second graphics processing pass; and
causing the geometry processor to continue performing the first graphics processing pass or the second graphics processing pass based on the determinations.

25. The method of claim 19, further comprising:
determining whether the first set of primitive indices does not comprise the at least one first primitive batch for the first graphics processing pass and whether the second set of primitive indices comprises the at least one second primitive batch for the second graphics processing pass; and
causing the geometry processor to perform the second graphics processing pass based on the determination.

26. The method of claim 18, wherein the first set of primitive indices in the at least one first primitive batch for the first graphics processing pass comprises a first quantity of indices and the second set of primitive indices in the at least one second primitive batch for the second graphics processing pass includes a second quantity of indices, the first quantity of indices being different than the second quantity of indices.

27. The method of claim 18, wherein the first graphics processing pass is a bin visibility pass and the second graphics processing pass is a bin rendering pass.

28. The method of claim 18, wherein the first graphics processing pass is a bin rendering pass and the second graphics processing pass is a bin visibility pass.

29. The method of claim 18, wherein the first graphics processing pass is a first bin rendering pass and the second graphics processing pass is a second bin rendering pass.

30. A non-transitory computer-readable medium storing computer-executable code, the code when executed by a processor causes the processor to:
store, in a graphics memory (GMEM), first data associated with a first graphics processing pass for a first frame of graphics data;
store, in the GMEM, second data associated with a second graphics processing pass for a second frame of graphics data;
cause a geometry processor to perform the first graphics processing pass using the first data; and
cause a second processor to perform the second graphics processing pass using the second data concurrently with the geometry processor performing the first graphics processing pass using the first data, wherein the first graphics processing pass and the second graphics processing pass share the geometry processor.
